(19) United States
(12) Patent Application Publication
(10) Pub. No.: US 2019/0052343 A1
(43) Pub. Date: Feb. 14, 2019

(54) Beam Recovery Request in Physical Uplink Control Channel

(71) Applicant: MEDIATEK INC., Hsinchu (TW)

(72) Inventors: Xiu-Sheng Li, Hsinchu (TW); Chia-Hao Yu, Hsinchu (TW)

(21) Appl. No.: 16/100,950

(22) Filed: Aug. 10, 2018

Related U.S. Application Data
(60) Provisional application No. 62/543,404, filed on Aug. 10, 2017.
(60) Provisional application No. 62/573,289, filed on Oct. 17, 2017.

(51) Int. Cl. H04B 7/08; H04B 7/06; H04W 72/04

(52) U.S. Cl. CPC H04B 7/088; H04W 72/0413; H04W 72/046; H04B 7/0626

(57) ABSTRACT

A method of beam recovery request (BRR) transmission is proposed. In a first step of beam failure detection, UE detects a beam failure condition of the original serving beam. In a second step of candidate beam identification, UE performs measurements for candidate beam selection. In a third step of BRR transmission, UE transmits a BRR message to BS upon the triggering condition for BRR is satisfied. In a fourth step of monitoring BS response, UE monitors BS response of the BRR transmission. In one advantageous aspect, the BRR transmission is over dedicated contention-free PUCCH resources, maybe with other uplink control information (UCI). Furthermore, the BRR message indicates the status of one or more configured beams, or the status of one or more identified beams, and reports corresponding beam quality indicators.

### CROSS REFERENCE TO RELATED APPLICATIONS

This application claims priority under 35 U.S.C. § 119 from U.S. Provisional Application No. 62/543,404, entitled “BRR in PUCCH,” filed on Aug. 10, 2017; U.S. Provisional Application No. 62/573,289, entitled “BRR on PUCCH in NR,” filed on Oct. 17, 2017, the subject matter of which is incorporated herein by reference.

### TECHNICAL FIELD

The disclosed embodiments relate generally to wireless communication, and, more particularly, to beam recovery request transmission design over physical uplink control channel (PUCCH) in a Millimeter Wave (mmW) beamforming new radio (NR) system.

### BACKGROUND

The bandwidth shortage increasingly experienced by mobile carriers has motivated the exploration of the underutilized Millimeter Wave (mmWave) frequency spectrum between 3G and 300G Hz for the next generation broadband cellular communication networks. The available spectrum of mmWave band is two hundred times greater than the conventional cellular system. The mmWave wireless network uses directional communications with narrow beams and can support multi-gigabit data rate. The underutilized bandwidth of the mmWave spectrum has wavelengths ranging from 1 mm to 100 mm. The very small wavelengths of the mmWave spectrum enable large number of miniaturized antennas to be placed in a small area. Such miniaturized antenna system can produce high beamforming gains through electrically steerable arrays generating directional transmissions. With recent advances in mmWave semiconductor circuitry, mmWave wireless system has become a promising solution for real implementation. However, the heavy reliance on directional transmissions and the vulnerability of the propagation environment present particular challenges for the mmWave network with beamforming.

In principle, beam training mechanism, which includes both initial beam alignment and subsequent beam tracking, ensures that base station (BS) beam and user equipment (UE) beam are aligned for data communication. To ensure beam alignment, beam-tracking operation should be adapted in response to channel changes. However, in mmWave systems, transmission path lifetime is expected one order of magnitude shorter than traditional cellular bands due to wavelength difference. Combined with dedicated beam with small spatial coverage, the number of effective transmission paths for a dedicated beam could be rather limited, thus more vulnerable to UE movements and environmental changes.

For beamformed access, both ends of a link need to know which beamformers to use. In downlink DL-based beam management, the BS side provides opportunities for UE to measure beamformed channel of different combinations of BS beams and UE beams. For example, BS performs periodic beam sweeping with reference signal (RS) carried on individual BS beams. UE can collect beamformed channel state by using different UE beams, and UE then report the collect information to BS. Apparently, UE has the most up-to-date beamformed channel state in DL-based beam management. BS learns the beamformed channel state based on UE feedback, and the feedback may include only strong beam pair links selected by UE.

Beam failure recovery mechanism is designed to handle the rare case beam tracking issue, e.g., when feedback rate for beam management may not be frequent enough. Beam recovery mechanism comprises triggering condition evaluation including beam failure detection and candidate beam identification, beam recovery request transmission, and network reaction monitoring. Details of the beam failure recovery procedures need to be carefully designed to shorten the recovery delay while ensure the robustness. Specifically, solutions for beam recovery request transmission over contention free physical uplink control channel (PUCCH) are sought.

### SUMMARY

A method of beam recovery request (BRR) transmission is proposed. In a first step of beam failure detection, UE detects a beam failure condition of the original serving beam. In a second step of candidate beam identification, UE performs measurements for candidate beam selection. In a third step of BRR transmission, UE transmits a BRR message to BS upon the triggering condition for BRR is satisfied. In a fourth step of monitoring BS response, UE monitors BS response of the BRR transmission. In one advantageous aspect, the BRR transmission is over dedicated contention-free PUCCH resources, maybe with other uplink control information (UCI). Furthermore, the BRR message indicates the status of one or more configured beams, or the status of one or more identified beams, and reports corresponding beam quality indicators.

In one embodiment, a UE monitors a plurality of reference signals based on a beam failure recovery configuration in a beamforming communication network. The UE detects a beam failure condition of one or more serving beam pair links (BPLs) and identifying one or more candidate beam pair links (BPLs). The UE generating a beam recovery request (BRR). The BRR indicates at least one of: one or more identified candidate beam indexes and one or more failed serving beam indexes. The UE reports the BRR to the base station over a physical uplink control channel (PUCCH) associated with a UE-identified candidate BPL.

In another embodiment, a base station transmits a beam failure recovery configuration to a user equipment (UE) over an established data connection using a serving beam pair link in a beamforming communication network. The base station schedules an uplink transmission of an uplink control information (UCI) for the UE over a physical uplink control channel (PUCCH). The base station receives a beam recovery request (BRR) message from the UE over the PUCCH. The BRR message indicates at least one of: one or more identified candidate beam indexes and one or more failed serving beam indexes.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a beamforming wireless communication system supporting a four-step beam failure recovery procedure using PUCCH for BRR transmission in accordance with one novel aspect.

FIG. 2 is a simplified block diagram of a base station and a user equipment that carry out certain embodiments of the present invention.

FIG. 3 illustrates beam failure detection and new beam identification in a four-step beam failure recovery procedure.

FIG. 4 illustrates beam recovery request transmission and response monitoring in a four-step beam failure recovery procedure.

FIG. 5 illustrates a first embodiment of BRR transmission utilizing PUCCH.

FIG. 6 illustrates a second embodiment of BRR transmission utilizing PUCCH.

FIG. 7 is a flow chart of a method of beam failure recovery from UE perspective in a beamforming system in accordance with one novel aspect.

FIG. 8 is a flow chart of a method of beam failure recovery from BS perspective in a beamforming system in accordance with one novel aspect.

### DETAILED DESCRIPTION

Reference will now be made in detail to some embodiments of the invention, examples of which are illustrated in the accompanying drawings.

FIG. 1 illustrates a beamforming wireless communication system 100 supporting a four-step beam failure recovery procedure using a physical uplink control channel (PUCCH) for beam recovery request (BRR) transmission in accordance with one novel aspect. Beamforming mmWave mobile communication network 100 comprises a base station BS 101 and a user equipment UE 102. The mmWave cellular network uses directional communications with beamformed transmission and can support up to multi-gigabit data rate. Directional communications are achieved via digital and/or analog beamforming, wherein multiple antenna elements are applied with multiple sets of beamforming weights to form multiple beams. In the example of FIG. 1, BS 101 is directionally configured with multiple cells, and each cell is covered by a set of TX/RX beams. For example, cell 110 is covered by a set of five BS beams #B1, #B2, #B3, #B4, and #B5. The collection of the BS beams #B1-#B5 covers an entire service area of cell 110. Similarly, UE 102 may also apply beamforming to form multiple UE beams, e.g., #U1 and #U2.

The set of BS beams may be periodically configured or occur indefinitely and repeatedly in order known to the UEs. Each BS beam broadcasts minimum amount of cell-specific and beam-specific information similar to System Information Block (SIB) or Master Information Block (MIB) in LTE systems, or synchronization signal block (SSB) in NR systems. Each BS beam may also carry UE-specific control or data traffic. Each BS beam transmits a set of known reference signals for the purpose of initial time-frequency synchronization, identification of the beam that transmits the signals, and measurement of radio channel quality for the beam that transmits the signals. In one example, a hierarchical control beam and dedicated data beam architecture provides a robust control-signaling scheme to facilitate the beamforming operation in mmWave cellular network systems.

In principle, beam training mechanism, which includes both initial beam alignment and subsequent beam tracking, ensures that BS beam and UE beam are aligned for data communication. For beamformed access, both ends of a link need to know which beamformers to use, e.g., a beam pair link (BPL). In downlink (DL)-based beam management, the BS side provides opportunities for UE to measure beamformed channel of different combinations of BS beams and UE beams. Apparently, UE has the most up-to-date beamformed channel state in DL-based beam management. BS learns the beamformed channel state based on UE feedback. The feedback rate for beamformed channel state is selected to take care of most beam tracking need. For rare cases beam tracking issue, however, such feedback rate for beam management may not be frequent enough. For example, a sudden blockage may result in lost connection. An additional mechanism is thus desired to address the need from rare cases.

In according with one novel aspect, a four-step beam failure recovery procedure from UE perspective is proposed. In a first step of beam failure detection, UE 102 detects a beam failure condition of the original serving BPL 131 formed between BS beam #B3 and UE beam #U2. In a second step of new candidate beam identification, UE 102 performs measurements for candidate beam selection. In a third step of beam recovery request (BRR) transmission, UE 102 transmits a BRR message to BS 101 upon the triggering condition for BRR transmission is satisfied. For example, the triggering condition is satisfied when beam failure is detected (e.g., the quality of the serving BPL is worse than a first predefined threshold) and candidate beam is identified (e.g., the quality of the candidate BPL is better than a second predefined threshold). In a fourth step of monitoring BS response, UE 102 monitors BS response to decide the success or failure of the BRR transmission attempt. For example, if the BRR transmission attempt is successful, then a new BPL 132 formed between BS beam #B2 and UE beam #U1 is selected to become the new serving BPL between BS 101 and UE 102. In one advantageous aspect, the BRR transmission is over dedicated contention-free PUCCH resources, maybe with other uplink control information (UCI). Furthermore, the BRR message indicates the status of one or more configured beams, or the status of one or more identified beams, and reports corresponding beam quality indicators.

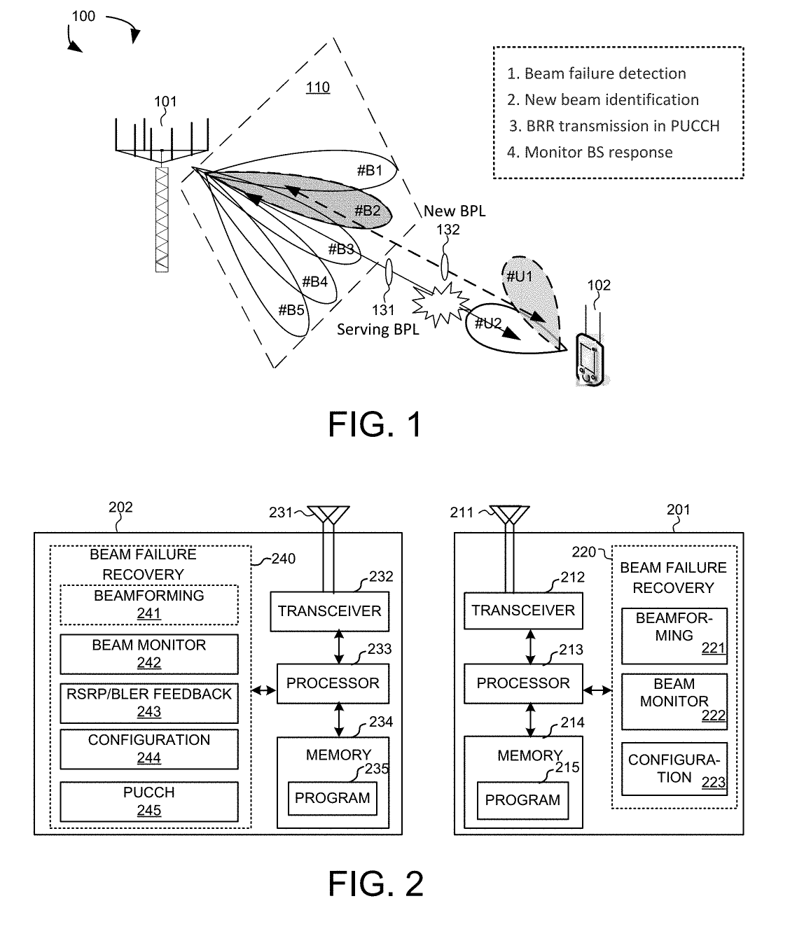

FIG. 2 is a simplified block diagram of a base station and a user equipment that carry out certain embodiments of the present invention. BS 201 has an antenna array 211 having multiple antenna elements that transmits and receives radio signals, one or more RF transceiver modules 212, coupled with the antenna array, receives RF signals from antenna 211, converts them to baseband signal, and sends them to processor 213. RF transceiver 212 also converts received baseband signals from processor 213, converts them to RF signals, and sends out to antenna 211. Processor 213 processes the received baseband signals and invokes different functional modules to perform features in BS 201. Memory 214 stores program instructions and data 215 to control the operations of BS 201. BS 201 also includes multiple function modules and circuits that carry out different tasks in accordance with embodiments of the current invention.

Similarly, UE 202 has an antenna 231, which transmits and receives radio signals. A RF transceiver module 232, coupled with the antenna, receives RF signals from antenna 231, converts them to baseband signals and sends them to processor 233. RF transceiver 232 also converts received baseband signals from processor 233, converts them to RF signals, and sends out to antenna 231. Processor 233 processes the received baseband signals and invokes different functional modules to perform features in UE 202. Memory 234 stores program instructions and data 235 to control the operations of UE 202. UE 202 also includes multiple function modules and circuits that carry out different tasks in accordance with embodiments of the current invention.

The functional modules and circuits can be implemented and configured by hardware, firmware, software, and any combination thereof. For example, BS 201 comprises a beam failure recovery module 220, which further comprises a beamforming circuit 221, a beam monitor 222, and a configuration circuit 223. Beamforming circuit 221 may belong to part of the RF chain, which applies various beamforming weights to multiple antenna elements of antenna 211 and thereby forming various beams. Beam monitor 222 monitors received radio signals and performs measurements of the radio signals over the various beams. Configuration and scheduling circuit 223 schedules uplink transmission for UEs and configures radio resources for UEs for uplink transmission using PUCCH.

Similarly, UE 202 comprises a beam failure recovery module 240, which further comprises a beamforming circuit 241, a beam monitor 242, a RSRP/BLER (reference signal received power or block error rate) feedback circuit 243, a configuration circuit 244, and a PUCCH handling circuit 245. Beamforming circuit 241 may belong to part of the RF chain, which applies various beamforming weights to multiple antenna elements of antenna 231 and thereby forming various beams. Beam monitor 242 monitors received radio signals and performs measurements of the radio signals over the various beams and maintains a ranking of its preferred BPLs. RSRP/BLER feedback circuit 243 provides beam quality feedback information to BS 201 for BPL alignment status determination. Configuration circuit 244 receives beam failure recovery configuration from BS 201, which includes beam failure recovery trigger conditions, beam failure recovery resources, and UE monitor/report behavior. Configuration circuit 244 also receives resource allocation from BS 201 for uplink transmission. PUCCH handling circuit 245 performs uplink transmission for both BRR and other UCI.

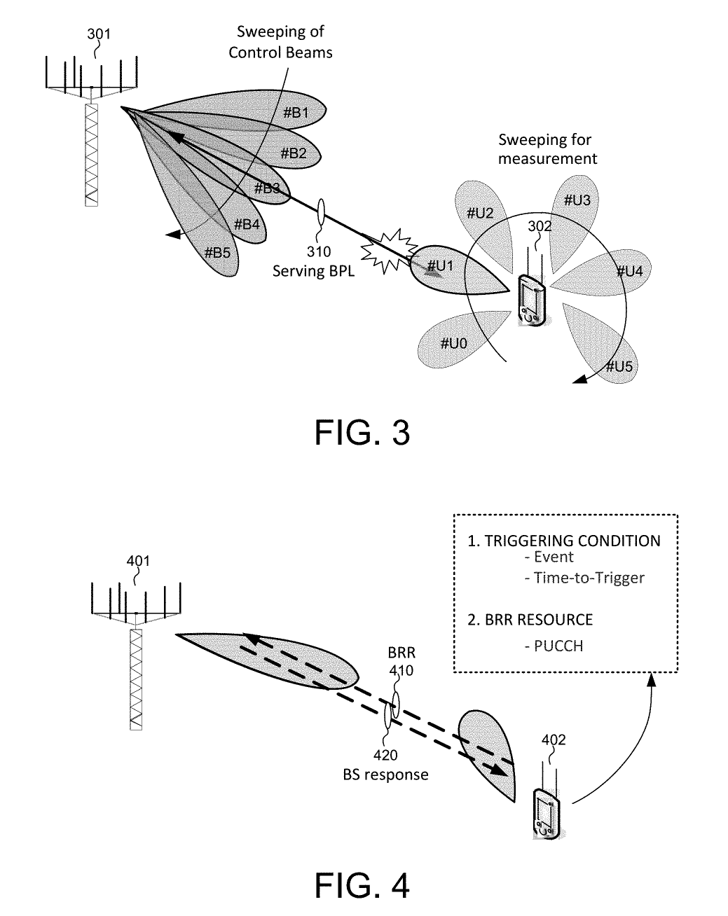

FIG. 3 illustrates beam failure detection and new beam identification in a four-step beam failure recovery procedure. In the example of FIG. 3, BS 301 is a serving base station for UE 302 and establishes a serving beam pair link (BPL) 310 with UE 302 for data communication. The serving BPL is associated to a serving control channel, e.g., a physical downlink control channel (PDCCH). One triggering condition for beam failure recovery is a beam failure detection of the serving BPL. Note that more than one serving BPLs may be used as serving control channels between the BS and the UE. In such case, beam failure recovery is triggered when all serving control channel fails. In one example, the beam failure is detected when the Block Error Rate (BLER) of the serving BPL is worse than a predefined threshold.

Another triggering condition for beam failure recovery is a candidate beam monitoring and new beam identification. In general, UE monitoring behavior follows similar procedure as DL beam management procedure in multi-beam operation. As depicted by FIG. 3, BS 301 transmits periodic DL RS by using a set of provisioned BS control beams #B1-#B5 with moderate beamforming gain. Individual beam-specific reference signals are transmitted in TDM/FDM/CDM (time division multiplex, frequency division multiplexed, or code division multiplexed) manner or a combination of them. UE monitors the quality of combinations of BS-UE BPLs in background by sweeping through different UE beams #U0-#U5. The beam quality is measured based on UE-specifically configured CSI-RS resources and/or SSB resources. The measurement metric for candidate beam selection is layer-1 reference signal received power (L1-RSRP). A new candidate BPL is identified when the L1-RSRP of the new candidate BPL is above a predefined threshold. UE keeps a ranking of its preferred candidate BPLs and can later select from the preferred candidate BPLs that are not currently used for beam failure recovery purpose.

FIG. 4 illustrates beam recovery request (BRR) transmission and response monitoring in a four-step beam failure recovery procedure. The BRR transmission involves two aspects, the first is the trigger condition, and the second is the selection of BRR resources. Triggering UE-initiated transmission for beam failure recovery requires UE to monitor both serving BPL(s) and good BPL(s) currently not used for communication. Both absolute and relative thresholds similar to RRC measurement events can be used. In one embodiment, the triggering condition for beam failure recovery is satisfied when the serving is worse than a first threshold and the candidate is better than a second threshold. Time-to-trigger can be applied for event evaluation, i.e., event criteria should be satisfied for a certain amount of time before triggering beam failure recovery request.

Once the triggering condition is satisfied for a predefined evaluation period, UE 402 transmits a Beam Recovery reQuest (BRR) 410 to BS 401 over beam failure recovery resources. In one embodiment, UE 402 is configured with dedicated beam failure recovery resource, e.g., UL control channel similar to LTE PUCCH. The dedicated resources correspond to individual BS receiving beams, e.g., individual PUCCHs for individual BS receiving beams for a UE. The dedicated resources carry information required for beam failure recovery action, e.g., DL BS beam ID of candidate BPL where beam failure recovery is to take place, triggered event (if multiple recovery events are configured), and candidate beam quality information. Selected candidate BPL can be associated with dedicated beam failure recovery resources directly/indirectly. UE beam used for BRR transmission depends on UE beam correspondence. Upon beam failure recovery request reception by BS 401, the network transmits a response 420 back to UE 402 and attempts connection with UE 402 in UE-indicated BPL.

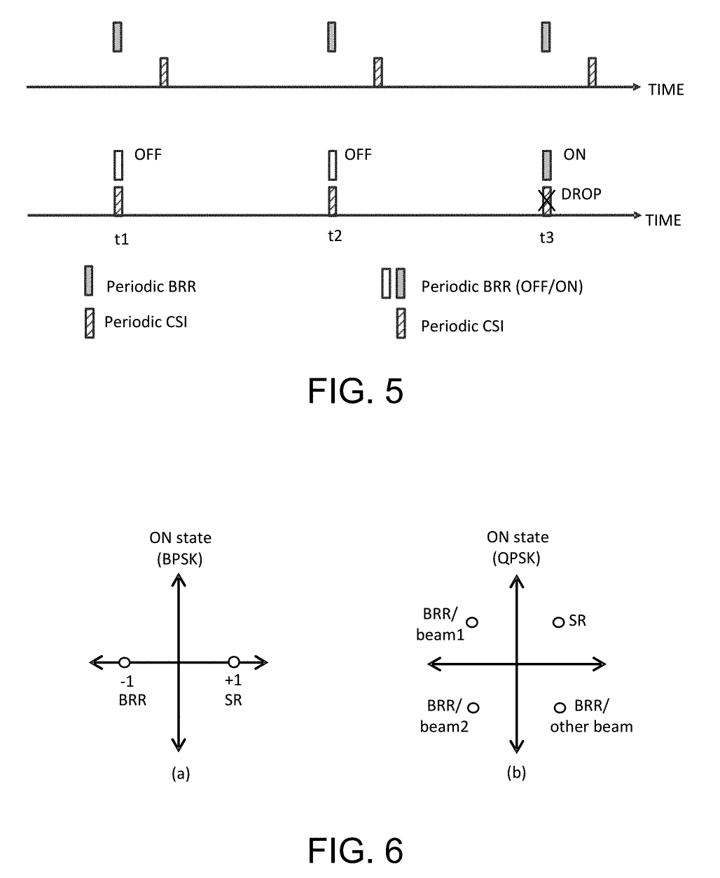

FIG. 5 illustrates a first embodiment of BRR transmission utilizing PUCCH. In the first embodiment, dedicated PUCCH resource is allocated to UE for BRR transmission only. The PUCCH format depends on the number of bits used for BRR message and appropriate PUCCH format can be assigned accordingly. Periodic or irregular BRR transmission can be configured with ON-OFF keying or non-ON-OFF keying solution. The PUCCH resource for BRR can be overlap or non-overlap with other PUCCH resource in time domain. In a first example of FIG. 5, periodic BRR transmission is configured having non-overlapping resource with other uplink transmission such as channel state information (CSI). In a second example of FIG. 5, periodic BRR transmission is configured with ON-OFF keying solution, having overlapping resource with uplink CSI transmission. In the second example, the periodic resource configured for BRR and for CSI overlaps in time domain. By design, BRR can have the highest priority and drop other transmission if necessary. If BRR transmission is OFF, e.g., at time t1 and t2, then UE performs CSI transmission. If BRR transmission is ON, e.g., at time t3, then CSI transmission is dropped.

There are different BRR mechanisms. In a first BRR mechanism, UE reports one or more failed beams and one or more newly identified beams with or without beam quality indicator. Preferably, the reported number of failed beams and the reported number of newly identified beams are the same. In one example, two failed beam indexes and two identified beam indexes are reported. In another example, one failed beam index, one identified beam index and its quality indicator are reported.

In a first special case of the first BRR mechanism, one or more new beams are identified and reported, and the corresponding beam quality indicators of the identified beams may also be reported. For instance, one newly identified beam index (SSB index or CSI-RS resource ID) and its associated L1-RSRP can be reported in BRR. A 13-bit BRR message may be used for reporting one new beam and its corresponding quality indicator: 6 bits for beam ID and 7 bits for beam quality. In a second special case of the first BRR mechanism, one or more failed beams and its beam quality indicators are reported. For instance, one failed beam ID and its corresponding beam quality indicator are reported in BRR.

In a second BRR mechanism, the UE reports the failure of a subset of beams. For example, a bitmap is used to indicate which of the beams are failed and at least one newly identified beam index. In a third BRR mechanism, the BRR indicates the status of the one or more monitored beams that are configured by the base station. For example, UE reports the failure of a subset of PDCCH control beams. UE uses a bitmap to indicate which PDCCH control beams are failed. If there are four monitored control beams, then four bits in total is used, each bit is used to indicate whether the monitored control beam quality is above or below a threshold.

If more than one BRR mechanisms are configured and they share the same PUCCH resource, then a BRR message header is introduced to differentiate the different BRR mechanisms. The BRR header length may depend on the configured number of BRR mechanisms. Padding bits can be used for reaching the same payload size if more than one BRR mechanisms are configured to share the same PUCCH resource. Otherwise, blind decoding for different payload sizes at the receiver can be applied.

FIG. 6 illustrates a second embodiment of BRR transmission utilizing PUCCH. In the second embodiment, dedicated PUCCH resource is allocated to UE for some UCI and BRR transmission. In one example, PUCCH is used for scheduling request (SR) and BRR transmission. Considering SR-only and BRR, BPSK modulation can be applied to differentiate SR and BRR when BRR is ON state, as depicted in FIG. 6(a). Alternatively, QPSK modulation can be applied to different SR, BRR with preferred beam1, BRR with preferred beam2, and BRR with other preferred wider beams when BRR is ON state, as depicted in FIG. 6(b). With QPSK modulation, the network may directly use preferred beam1 or beam2 or other wider beams to trigger subsequent beam management procedure.

In another example, PUCCH is used for both CSI reporting and BRR transmission. The CSI may include RI/PMI/CQI (rank indicator, precoding matrix indicator, and channel quality indicator) as in LTE and potential beam related information in NR. In a first example, periodic CSI reporting needs total of 13 bits with 6-bit beam index and 7-bit quality indicator. BRR mechanism needs 12 bits with 6-bit for one failed beam index and 6-bit for one identified beam index. One additional bit is introduced to differentiate CSI and BRR. To reduce decoding effort, one padding bit for BRR can be inserted to align the payload size of CSI reporting. In a second example, periodic CSI reporting needs total of 52 bits with 6-bit beam index and 7-bit quality indicator for each of the four control beams. BRR mechanism needs 13 bits with 6-bit for new beam ID and 7-bit for quality indicator. One additional bit is introduced to differentiate CSI and BRR. To reduce decoding effort, padding bits for BRR can be inserted to align the payload size of CSI reporting. Alternatively, no additional bit is used and the network needs to do blind decoding to differentiate CSI and BRR. In a third example, periodic CSI reporting contains X bits in total, with some unused states represented by X bits, e.g., S₀˜Sₙ₋₁. The unused states (S₀˜Sₙ₋₁) are used for BRR indication. If there is only one unused state S₀, then S₀ is used as BRR. If there are at least two unused states, e.g. S₀ and S₁, then S₀ can be used as BRR with preferred predefined beam1, and S₁ can be used as BRR with preferred predefined beam2, etc. As a result, no additional bit is required to differentiate CSI and BRR reporting.

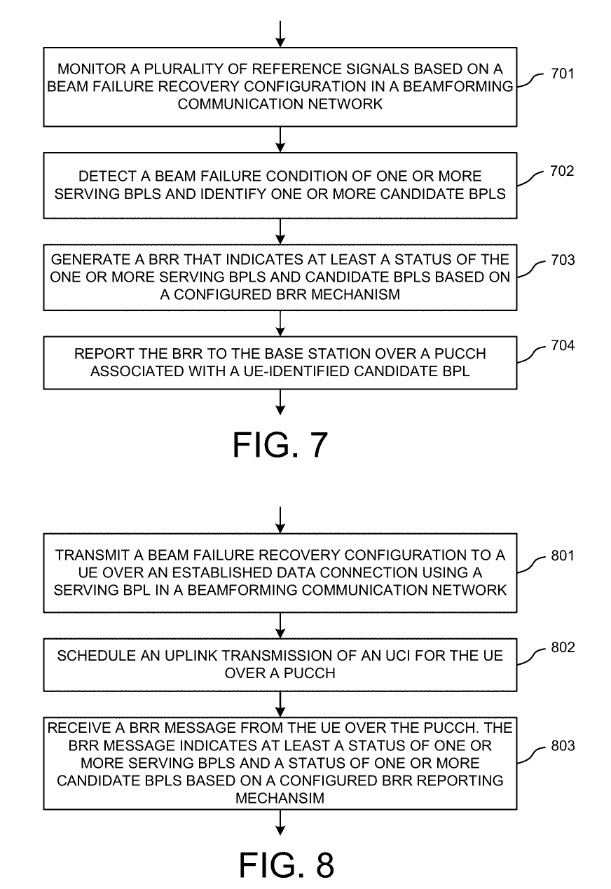

FIG. 7 is a flow chart of a method of beam failure recovery from UE perspective in a beamforming system in accordance with one novel aspect. In step 701, a UE monitors a plurality of reference signals based on a beam failure recovery configuration in a beamforming communication network. In step 702, the UE detects a beam failure condition of one or more serving beam pair links (BPLs) and identifying one or more candidate beam pair links (BPLs). In step 703, the UE generating a beam recovery request (BRR). The BRR indicates at least one of: one or more identified candidate beam indexes and one or more failed serving beam indexes. In step 704, the UE reports the BRR to the base station over a physical uplink control channel (PUCCH) associated with a UE-identified candidate BPL.

FIG. 8 is a flow chart of a method of beam failure recovery from BS perspective in a beamforming system in accordance with one novel aspect. In step 801, a base station transmits a beam failure recovery configuration to a user equipment (UE) over an established data connection using a serving beam pair link in a beamforming communication network. In step 802, the base station schedules an uplink transmission of an uplink control information (UCI) for the UE over a physical uplink control channel (PUCCH). In step 803, the base station receives a beam recovery request (BRR) message from the UE over the PUCCH. The BRR message indicates at least one of: one or more identified candidate beam indexes and one or more failed serving beam indexes.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
monitoring a plurality of reference signals by a user equipment (UE) based on a beam failure recovery configuration in a beamforming communication network;
detecting a beam failure condition of one or more serving beam pair links (BPLs) and identifying one or more candidate beam pair links (BPLs);
generating a beam recovery request (BRR), wherein the BRR indicates at least one of: one or more identified candidate beam indexes and one or more failed serving beam indexes; and
reporting the BRR to the base station over a physical uplink control channel (PUCCH) associated with a UE-identified candidate BPL.

2. The method of claim 1, wherein the BRR indicates at least one of: a beam quality of an identified candidate beam, a beam quality of a failed serving beam, and status of one or more configured beams.

3. The method of claim 1, wherein the BRR is transmitted over a dedicated PUCCH resource allocated for the BRR transmission.

4. The method of claim 3, wherein the dedicated PUCCH resource overlaps with PUCCH resource allocated for channel state information (CSI) transmission, and wherein the BRR transmission has a higher priority over the CSI transmission.

5. The method of claim 1, wherein the BRR is transmitted over a PUCCH resource allocated for both the BRR transmission and an uplink control information (UCI) transmission.

6. The method of claim 5, wherein the UCI comprises a scheduling request (SR), and wherein a modulation is applied for differentiating the SR and the BRR.

7. The method of claim 5, wherein the UCI comprises a channel state information (CSI), and wherein an extra bit is used to differentiate the CSI and the BRR.

8. The method of claim 5, wherein the UCI comprises a channel state information (CSI) containing a plurality of bits, and wherein one or more unused states represented by the plurality of bits are used as the BRR.

9. The method of claim 1, wherein the BRR indicates beam indexes based on at least one of multiple BRR mechanisms configuring to share the same PUCCH resource, and wherein a BRR header is inserted to differentiate the multiple BRR mechanisms.

10. A user equipment (UE), comprising:
a radio frequency (RF) receiver that receives a plurality of reference signals based on a beam failure recovery configuration in a beamforming communication network;
a beam monitoring circuit that detects a beam failure condition of one or more serving beam pair links (BPLs) and identifies one or more candidate beam pair links (BPLs);
a beam failure recovery circuits that generates a beam recovery request (BRR), wherein the BRR indicates at least one of: one or more identified candidate beam indexes and one or more failed serving beam indexes; and
an RF transmitter that transmits the BRR to the base station over a physical uplink control channel (PUCCH) associated with a UE-identified candidate BPL.

11. The UE of claim 10, wherein the BRR indicates at least one of: a beam quality of an identified candidate beam, a beam quality of a failed serving beam, and status of one or more configured beams.

12. The UE of claim 10, wherein the BRR is transmitted over a dedicated PUCCH resource allocated for the BRR transmission.

13. The UE of claim 12, wherein the dedicated PUCCH resource overlaps with PUCCH resource allocated for channel state information (CSI) transmission, and wherein the BRR transmission has a higher priority over the CSI transmission.

14. The UE of claim 10, wherein the BRR is transmitted over a PUCCH resource allocated for both the BRR transmission and an uplink control information (UCI) transmission.

15. The UE of claim 14, wherein the UCI comprises a scheduling request (SR), and wherein a modulation is applied for differentiating the SR and the BRR.

16. The UE of claim 14, wherein the UCI comprises a channel state information (CSI), and wherein an extra bit is used to differentiating the CSI and the BRR.

17. The UE of claim 14, wherein the UCI comprises a channel state information (CSI) containing a plurality of bits, and wherein one or more unused states represented by the plurality of bits are used as the BRR.

18. The UE of claim 10, wherein the BRR indicates beam indexes based on at least one of multiple BRR mechanisms configuring to share the same PUCCH resource, and wherein a BRR header is inserted to differentiate the multiple BRR mechanisms.

19. A base station, comprising:
a transmitter that transmits a beam failure recovery configuration to a user equipment (UE) over an established data connection using a serving beam pair link in a beamforming communication network;
a scheduling circuit that schedules an uplink transmission of an uplink control information (UCI) for the UE over a physical uplink control channel (PUCCH); and
a receiver that receives a beam recovery request (BRR) message from the UE over the PUCCH, wherein the BRR message indicates at least one of: one or more identified candidate beam indexes and one or more failed serving beam indexes.

20. The base station of claim 19, wherein the beam failure recovery configuration comprises beam failure recovery trigger conditions, beam failure recovery resources, UE monitoring behavior, and BRR reporting mechanism.
